(19) United States
(12) Patent Application Publication
(10) Pub. No.: US 2018/0121984 A1
(43) Pub. Date: May 3, 2018

(54) AUTOMATED PRIVACY FILTER FOR GIFT REGISTRY

(71) Applicant: INTERNATIONAL BUSINESS MACHINES CORPORATION, ARMONK, NY (US)

(72) Inventors: JIALIN LI, WESTFORD, MA (US); PRADEEP K. NANJUNDASWAMY, BANGALORE (IN); DANAI TENGTRAKOOL, BURLINGTON, MA (US)

(21) Appl. No.: 15/335,848

(22) Filed: Oct. 27, 2016

(51) Int. Cl. G06Q 30/06

(52) U.S. Cl. CPC G06Q 30/0625; G06Q 30/0633

(57) ABSTRACT

In response to adding an item onto an on-line gift registry for publication to viewers as a requested gift item for a gift recipient, aspects determine whether sensitive personal information about the gift recipient is indicated by an item identity attribute or a generic category applicable to the item. In response to determining that the sensitive personal information is thereby indicated, aspects generate a publication of the item to the gift registry that provides a selective item identification that omits the item identity attribute, or provides an identification of the generic category applicable to the item. In response to a purchase of the item as a gift for the gift recipient by a purchasing viewer of the generated gift registry publication, aspects give purchase information to the purchasing viewer that confirms the purchase transaction and conveys either of the selective item identification and the generic category identification.

### BACKGROUND

Online gift list and gift registry systems provide convenient ways of sharing the identification of goods and services that persons would like to receive as gifts from others. Generally a gift recipient selects items for inclusion within a gift registry as a desired gift. Such registries are dynamically updated in response to purchases of item listed therein, wherein other persons viewing the registry see the items, along with indications of a desired number of the items, pricing per item, and a running tally of items that have been purchased by donors. When a desired number of listed items are purchased by gifting others, the registry generally indicates this status, wherein the gift recipient's request for the item is generally deemed satisfied and the item removed from a list of active items that are available for purchase. Thus, viewers of the registry are generally provided with notices of remaining items (or numbers thereof) that are still available for purchase as a gift, wherein their purchase by the viewer or other donor would satisfy requests of the gift recipient for suggested gifts.

### BRIEF SUMMARY

In one aspect of the present invention, a computerized method for the automated redaction of sensitive item information from published gift registries executes steps on a computer processor. In response to adding an item onto an on-line gift registry for publication to viewers as a requested gift item for a gift recipient, aspects determine whether sensitive personal information about the gift recipient is indicated by identification indicia of the item that includes an item identity attribute and a generic category that is applicable to the item. In response to determining that the sensitive personal information about the gift recipient is indicated by the item identification indicia, aspects generate a publication of the item to the gift registry that provides a selective item identification that omits the item identity attribute, or an identification of the generic category applicable to the item. In response to a purchase of the item as a gift for the gift recipient by a purchasing viewer of the generated gift registry publication, aspects give purchase information to the purchasing viewer that confirms the purchase transaction and conveys either of the selective item identification and the generic category identification.

In another aspect, a system has a hardware processor in circuit communication with a computer readable memory and a computer-readable storage medium having program instructions stored thereon. The processor executes the program instructions stored on the computer-readable storage medium via the computer readable memory and thereby, in response to adding an item onto an on-line gift registry for publication to viewers as a requested gift item for a gift recipient, determine whether sensitive personal information about the gift recipient is indicated by identification indicia of the item that includes an item identity attribute and a generic category that is applicable to the item. In response to determining that the sensitive personal information about the gift recipient is indicated by the item identification indicia, aspects generate a publication of the item to the gift registry that provides a selective item identification that omits the item identity attribute, or an identification of the generic category applicable to the item. In response to a purchase of the item as a gift for the gift recipient by a purchasing viewer of the generated gift registry publication, aspects give purchase information to the purchasing viewer that confirms the purchase transaction and conveys either of the selective item identification and the generic category identification.

In another aspect, a computer program product for the automated redaction of sensitive item information from published gift registries has a computer-readable storage medium with computer readable program code embodied therewith. The computer readable hardware medium is not a transitory signal per se. The computer readable program code includes instructions for execution which cause the processor to, in response to adding an item onto an on-line gift registry for publication to viewers as a requested gift item for a gift recipient, determine whether sensitive personal information about the gift recipient is indicated by identification indicia of the item that includes an item identity attribute and a generic category that is applicable to the item. In response to determining that the sensitive personal information about the gift recipient is indicated by the item identification indicia, aspects generate a publication of the item to the gift registry that provides a selective item identification that omits the item identity attribute, or an identification of the generic category applicable to the item. In response to a purchase of the item as a gift for the gift recipient by a purchasing viewer of the generated gift registry publication, aspects give purchase information to the purchasing viewer that confirms the purchase transaction and conveys either of the selective item identification and the generic category identification.

### BRIEF DESCRIPTION OF THE DRAWINGS

These and other features of embodiments of the present invention will be more readily understood from the following detailed description of the various aspects of the invention taken in conjunction with the accompanying drawings in which:

FIG. 1 depicts a cloud computing environment according to an embodiment of the present invention.

FIG. 2 depicts a cloud computing node according to an embodiment of the present invention.

FIG. 3 depicts a computerized aspect according to an embodiment of the present invention.

FIG. 4 is a flow chart illustration of a process or system for the automated redaction of sensitive item information from published gift registries according to an embodiment of the present invention.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

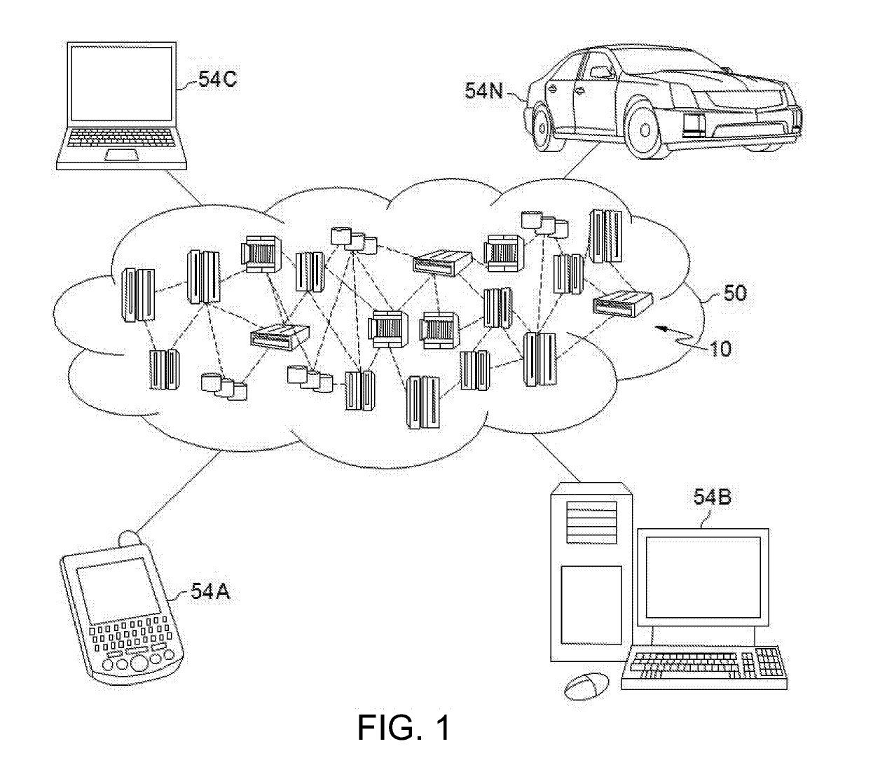

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

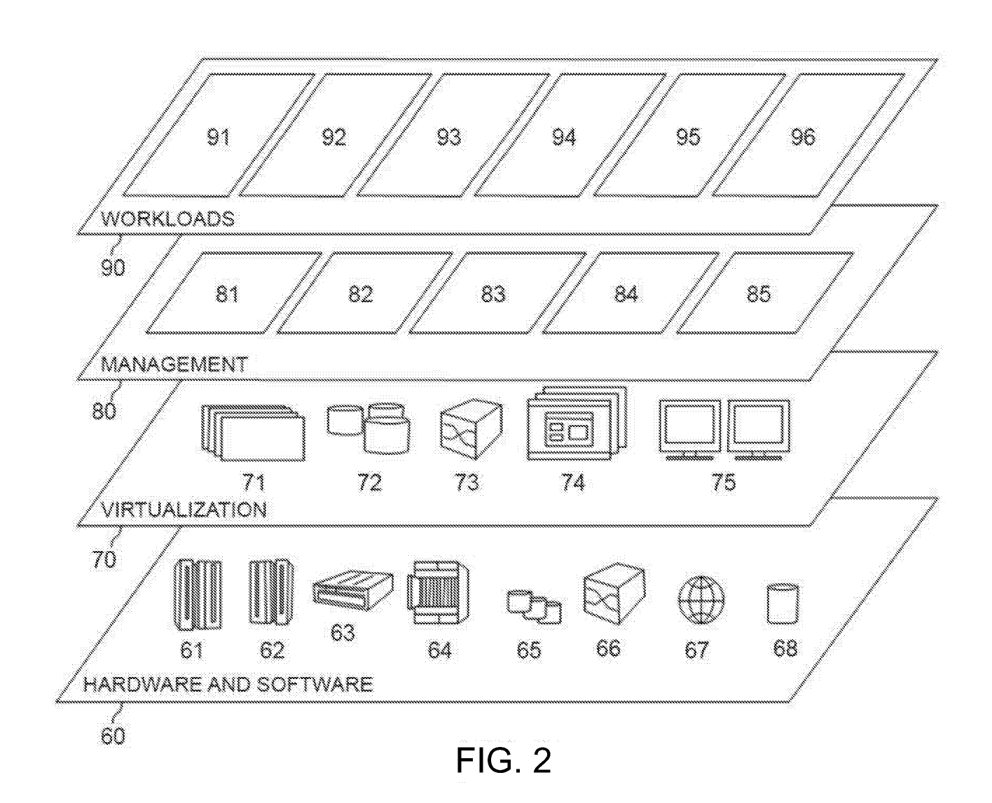

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

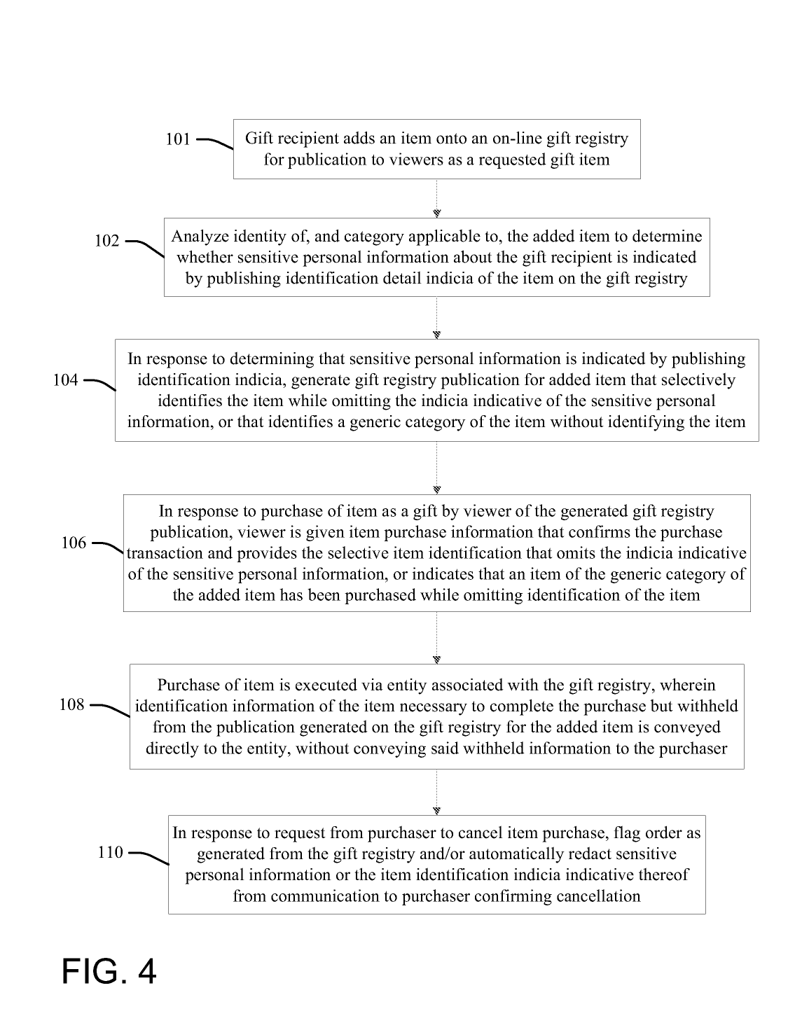

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing 96 for the automated redaction of sensitive item information from published gift registries according to embodiments of the present invention, for example to execute the process steps or system components or tasks as depicted in FIG. 4 below.

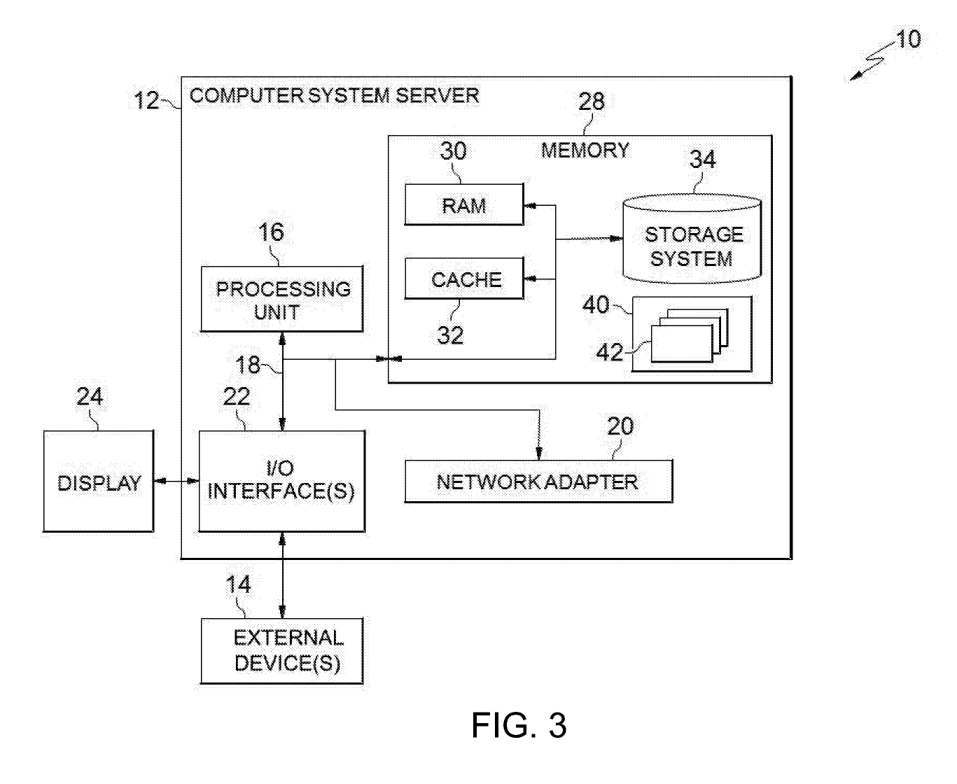

FIG. 3 is a schematic of an example of a programmable device implementation 10 according to an aspect of the present invention, which may function as a cloud computing node within the cloud computing environment of FIG. 2. Programmable device implementation 10 is only one example of a suitable implementation and is not intended to suggest any limitation as to the scope of use or functionality of embodiments of the invention described herein. Regardless, programmable device implementation 10 is capable of being implemented and/or performing any of the functionality set forth hereinabove.

A computer system/server 12 is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

The computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

Prior art online gift list and gift registry systems may overtly or inherently disclose confidential information with respect to the recipient of a registered gift. Providing sufficient information to identify a good or service so that a donor may purchase an item for a gift recipient may reveal information about the recipient that he or she may not wish to share with others. For example, listing apparel within a gift registry generally requires an indication of sizing, in order to enable the purchase of apparel that fits the gift recipient. However, identifying apparel sizing expressly or inherently discloses physical attributes of the gift recipient.

Gift registries may be shared or published on social networks, which may greatly expand the scope of unwanted publication of such confidential information. Thus, in order to protect their privacy from viewers of the gift registry, gift recipients are discouraged from listing certain desired items that may convey confidential or personal information to a view of the registry. This results in dissatisfaction for gift recipients when they cannot list all desired gift items. It also results in correspondingly lowered sale revenue potentials for online retailers hosting such gift registries.

FIG. 4 illustrates a process or system according to the present invention for automated redaction of sensitive item information from published gift registries. At 101 an item is added onto an on-line wish list or gift registry for publication to donors or other viewers of the gift registry as a requested gift item for a gift recipient. In response to the addition of the item to the registry, at 102 aspects determine whether sensitive personal information about the gift recipient is indicated by publishing one or more identification indicia of the item. The identification indicia may be particular attribute or detail of the item, or a generic category that is applicable to the item.

At 104, in response to determining that sensitive personal information about the gift recipient is indicated by the item identification indicia, aspects generate a publication to the gift registry for the added item that (i) selectively identifies the item while omitting the item identity attribute found indicative of the sensitive personal information; and/or (ii) publishes the generic category applicable to the item, while omitting any specific identification of the item that would distinguish it from different, other items that also fall within the generic category.

At 106, in response to a purchase of the added item as a gift for the gift recipient by a viewer of the generated gift registry publication, the viewer is given item purchase information that confirms the purchase transaction and either of (i) the selective item identification that omits the item identity attribute, and (ii) indicates that an item of the generic category of the added item has been purchased while omitting identification of the item (omitting information that identifies or distinguishes the item from other, different, non-purchased items within the same, generic category).

At 108 purchase of the item is executed via a retailer or other entity associated with the gift registry, wherein identification information of the item necessary to complete the purchase but withheld from the publication generated on the gift registry for the added item is conveyed directly to the entity, without conveying said withheld information to the purchaser.

At 110, in response to a subsequent request from the purchaser to cancel the purchase, aspects flag the order as generated from the gift registry, and thereby presume that the order generated at 108 comprises sensitive personal information about the gift recipient, or item identification indicia indicative of the sensitive personal information. Thus, the sensitive personal information or the item identification indicia indicative thereof are redacted or otherwise automatically removed from subsequent communications to the purchaser confirming the cancellation. Aspects also provide notifications to customer service representatives (via highlighting, bulletins, flags, etc.) to omit or redact the sensitive personal information or the item identification indicia indicative thereof from any communications with the purchasers.

Electronic commerce (“ecommerce”) providers of the gift registry generally hide sensitive attributes of the product including item identification indicia that are indicative of sensitive personal information about the gift recipient from all relevant on-line web pages that may be viewable by the viewers of the gift registry, including history order detail pages, product pages, shopping cart pages, etc. Generally this sensitive information is not stored in user interface (UI) of hypertext mark-up language (HTML) sources accessible to the viewers of the gift registry. Instead, the added item is linked to the gift registry, and the ecommerce system has access to the item identification indicia even though it is not passed by a browser of the viewer of the gift registry. The ecommerce system saves (stores) values of the item identification indicia when the item is published to the gift registry, and uses the stored values to resolve the missing data that is not passed by the browser to execute the purchase at 108.

Sensitive information item identification indicia includes data that directly or indirectly conveys sizing for apparel items, wheel chairs, bicycle seats, etc. For example, listing apparel within a gift registry generally requires an indication of sizing, in order to enable the purchase of apparel that fits the gift recipient. However, identifying apparel sizing expressly or inherently discloses physical attributes of the gift recipient, such as a range of possible waist sizes, chest sizes, shoe or foot sizes, etc. Body weight values or ranges may be readily estimated from apparel sizing dimensions, particular in view of other personal data, such as height, shoe size, etc. Such information may be considered personal and confidential by the gift recipient.

Sensitive information may also include weight-ratings, such as for infant car seats, strollers, walkers, wheel chairs, etc. Weight rating information may directly or inherently indicate the minimum weight, or weight range, of the gift recipient or of their child or other intended beneficiary of the purchased item.

The identification of the requested item itself may be considered sensitive information for items that are categorized within certain sensitive item categories. For example, therapeutic massage sessions, physical therapy services, dietary consultations, hair treatments and trimming instruments and dyes, bandages, moisture absorbing pads, ointments, and other personal care items may be considered by a gift recipient to convey personal and sensitive information with regard to their personal needs or desires. Accordingly, aspects may determine (including at 104) that a registered item falls within a generic sensitive item category, and in response identify only the category itself on the gift registry as representative of the item, along with any other useful purchasing information. An exemplary gift registry publication includes “Personal Care goods or services item, $10 increments available, $50 purchased to-date of total amount requested of $200”. Still others will be apparent to one skilled in the art.

Suitable age or employment information may also be disclosed by identification attributes published with respect to a gift registry item. For example, publishing the pricing of an item may convey a discount conveyed only to retired recipients, or to recipients having ages above a retirement age designated by a tax code or retailer policy, etc., wherein the discount is not available to other recipients how are still employed full-time or are younger than the designated age. Accordingly, the publication of the registered requested item may identify an item but omit the specific pricing of the item, instead just indicating purchase amount increments available, and amounts purchased to-date out of a total amount requested. The purchaser need not be informed as to how many items, or what quantity of services, their gift actually resulted in, merely that their purchased amount has been allocated toward satisfying the total amount requested.

Stock keeping unit (SKU) identifiers function as unique identification codes for a retailer or product, often deployed within machine-readable bar codes that help track an item for inventory. SKU's may also appear on retailer web page publications of offers to sell an item to a purchaser utilizing a gift registry. In some cases SKU data may uniquely distinguish between varieties of items by indicating their particular sizing, color, weight-rating, etc. Thus, an SKU may indirectly convey the sizing, weight rating, etc., of an item to a purchaser, even if redacted from registry publications. For example, a viewer of the gift registry may search other retailers or sources for SKU number used to identify an item, wherein the other sources may provide both pricing and the sensitive sizing or weight-rating information in a published offer for the listed item. Accordingly, aspects of the present invention generally omit SKU numbers from publications of items available on the gift registry, while workers in a warehouse or store fulfilling the order will be able to see the SKU number and other full description information so that they can pick, pack and ship a correct item product to the gift recipient.

Thus, aspects of the present invention empower gift recipient with the ability to confidently control the visibility of certain sensitive information about goods and service they may request in gift registries. User may confidently add any desired items to a gift registry, without worrying about sharing personal information inherent in the desire of the registered item, or conveying any information with respect to their use of the item. Only information necessary to enable viewers to identify a general category of the gift and to execute a purchase of the desired item via category or generic grouping need be conveyed, and not the specific, unique identification of the gift itself.

The terminology used herein is for describing particular aspects only and is not intended to be limiting of the invention. As used herein, the singular forms “a”, “an” and “the” are intended to include the plural forms as well, unless the context clearly indicates otherwise. It will be further understood that the terms “include” and “including” when used in this specification specify the presence of stated features, integers, steps, operations, elements, and/or components, but do not preclude the presence or addition of one or more other features, integers, steps, operations, elements, components, and/or groups thereof. Certain examples and elements described in the present specification, including in the claims and as illustrated in the figures, may be distinguished or otherwise identified from others by unique adjectives (e.g. a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for the automated redaction of sensitive item information from a published gift registry, comprising executing on a computer processor:
determining that an item added onto an on-line gift registry for publication to viewers as a requested gift item for a gift recipient is categorized within a sensitive item category as a function of determining that an identification of the item is selected from the group consisting of a physical therapy service, an exercise instruction service, a dietary consultation service, a therapeutic massage session, an ointment, a hair treatment, a bandage, a weight rating of the item, and an attribute associated with an age of the gift recipient;
in response to the determining that the item added onto the on-line gift registry for publication to viewers as the requested gift item for the gift recipient is categorized within the sensitive item category, generating a publication of the item to the gift registry that omits the identification and identifies a generic personal care category that is applicable to the item;
determining that a purchasing viewer of the generated publication of the item to the gift registry purchased the item as a gift for the gift recipient; and
in response to the determining of the purchase of the item as the gift for the gift recipient by the purchasing viewer, presenting a confirmation of a purchase transaction to the purchasing viewer that omits the identification and identifies an item amount of the generic personal care category purchased.

2. The method of claim 1, further comprising:
executing purchase of the added item via an entity associated with the gift registry by conveying the item identification to the entity to complete the purchase.

3. (canceled)

4. The method of claim 1, further comprising:
receiving a request from the purchasing viewer to cancel the purchase; and
redacting the item identification and any associated sensitive personal information from a communication generated to the purchasing viewer that confirms the cancellation.

5. The method of claim 1, further comprising:
determining that sensitive personal information about the gift recipient is indicated by a value of the item identification;
storing the value of the item identification; and
using the stored value to resolve missing data that is not passed by a browser of the purchasing viewer to execute the purchase of the item as a gift for the gift recipient.

6. The method of claim 5, wherein the value of the identification is
a stock keeping unit identifier; and
wherein the generated publication omits the value of the identification.

7. (canceled)

8. The method of claim 1, further comprising:
redacting the item identification from a plurality of different on-line web pages of the gift registry that are each viewable by the purchasing viewer.

9. The method of claim 8, wherein the plurality of different on-line web pages of the gift registry that are each viewable by the purchasing viewer are selected from the group consisting of a history order detail page, a product page, and a shopping cart page.

10. The method of claim 1, further comprising:
integrating computer-readable program code into a computer system comprising a processor, a computer readable memory and a computer readable storage medium, wherein the computer readable program code is embodied on the computer readable storage medium and comprises instructions that, when executed by the processor via the computer readable memory, cause the processor to perform the determining that the item is categorized within the sensitive item category, the generating the publication of the item to the gift registry, the determining that the purchasing viewer purchased the item as the gift for the gift recipient, and the presenting the confirmation of the purchase transaction to the purchasing viewer.

11. The method of claim 10, wherein the computer-readable program code is provided as a service in a cloud environment.

12. A system, comprising:
a processor;
a computer readable memory in circuit communication with the processor; and
a computer readable storage medium in circuit communication with the processor;
wherein the processor executes program instructions stored on the computer-readable storage medium via the computer readable memory and thereby:
determines that an item added onto an on-line gift registry for publication to viewers as a requested gift item for a gift recipient is categorized within a sensitive item category as a function of determining that an identification of the item is selected from the group consisting of a physical therapy service, an exercise instruction service, a dietary consultation service, a therapeutic massage session, an ointment, a hair treatment, a bandage, a weight rating of the item, and an attribute associated with an age of the gift recipient;
in response to determining that the item added onto the on-line gift registry for publication to viewers as the requested gift item for the gift recipient is categorized within the sensitive item category, generates a publication of the item to the gift registry that identifies a generic personal care category that is applicable to the item and omits the identification;
determines that a purchasing viewer of the generated publication of the item to the gift registry purchased the item as a gift for the gift recipient; and
in response to the determined purchase of the item as the gift for the gift recipient by the purchasing viewer, presents a confirmation of a purchase transaction to the purchasing viewer that omits the identification and identifies an item amount of the generic personal care category purchased.

13. (canceled)

14. The system of claim 12, wherein the processor executes the program instructions stored on the computer-readable storage medium via the computer readable memory and thereby:
redacts the item identification and any associated sensitive personal information from a communication generated to the purchasing viewer that confirms the cancellation.

15. The system of claim 12, wherein the processor executes the program instructions stored on the computer-readable storage medium via the computer readable memory and thereby:
determines that sensitive personal information about the gift recipient is indicated by a value of the item identification;
stores the value of the item identification; and
uses the stored value to resolve missing data that is not passed by a browser of the purchasing viewer to execute the purchase of the item as a gift for the gift recipient.

16. A computer program product for the automated redaction of sensitive item information from a published gift registry, the computer program product comprising:
a computer readable storage medium having computer readable program code embodied therewith, wherein the computer readable storage medium is not a transitory signal per se, the computer readable program code comprising instructions for execution by a processor that cause the processor to:
determine that an item added onto an on-line gift registry for publication to viewers as a requested gift item for a gift recipient is categorized within a sensitive item category as a function of determining that an identification of the item is selected from the group consisting of a physical therapy service, an exercise instruction service, a dietary consultation service, a therapeutic massage session, an ointment, a hair treatment, a bandage, a weight rating of the item, and an attribute associated with an age of the gift recipient;
in response to determining that the sensitive personal information about the gift recipient is indicated by the item identification indicia, generate a publication of the item to the gift registry that identifies a generic personal care category that is applicable to the item and omits the identification;
determines that a purchasing viewer of the generated publication of the item to the gift registry purchased the item as a gift for the gift recipient; and
in response to the determined purchase of the item as the gift for the gift recipient by the purchasing viewer, present a confirmation of a purchase transaction to the purchasing viewer that omits the identification and identifies an item amount of the generic personal care category purchased.

17. The computer program product of claim 16, wherein a value of the identification is a stock keeping unit identifier that is indicative of sensitive personal information about the gift recipient; and
wherein the generated publication omits the value.

18. (canceled)

19. The computer program product of claim 16, wherein the computer readable program code instructions for execution by the processor further cause the processor to:
redact the item identification from a plurality of different on-line web pages of the gift registry that are each viewable by the purchasing viewer.

20. The computer program product of claim 19, wherein the plurality of different on-line web pages of the gift registry that are each viewable by the purchasing viewer are selected from the group consisting of a history order detail page, a product page, and a shopping cart page.
